(19) United States
(12) Patent Application Publication
(10) Pub. No.: US 2006/0140527 A1
(43) Pub. Date: Jun. 29, 2006

(54) Thrust roller bearing apparatus

(75) Inventors: Wataru Takamizawa, Tokyo (JP); Hiroshi Sato, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 11/296,867

(22) Filed: Dec. 8, 2005

(30) Foreign Application Priority Data
Dec. 9, 2004 (JP) P2004-356249

(51) Int. Cl. F16C 33/34

(52) U.S. Cl. 384/620

(57) ABSTRACT

A thrust roller bearing apparatus is such as to be installed in a hydraulic mechanism to adjust a gap produced between components when they are assembled in the hydraulic mechanism and is configured such that a back side of a race forms an oil pressure chamber in a space produced between the back side of the race and a mating member which the race oppositely faces, so that the race bears a pressure from the oil pressure chamber so as to be displaced axially to thereby carry out the adjustment of the gap.

### BACKGROUND OF THE INVENTION

The present invention relates to a thrust roller bearing apparatus which is installed in a hydraulic mechanism which operates by virtue of oil pressure such as an automatic transmission for a motor vehicle so as to adjust an axial gap which occurs between components making up the hydraulic mechanism when the respective components are assembled thereinto, the gap occurring due to the dispersion in axial dimensions thereof.

Automatic transmissions using torque converters are how becoming a main stream of automatic transmissions. The automatic transmissions are constructed by assembling a number of transmission components along axial directions of an input shaft and an output shaft which are installed in a housing thereof However, due to dimensional dispersion present in relation to width dimensions and assembly dimensions of the respective components, a slight gap (assembly gap) of on the order of 1 mm is generated between components which is finally assembled in the axial direction and the housing. It is a common practice to adjust the assembly gap by inserting a gap adjusting member such as a washer and shir in the assembly gap so that the assembly gap does not affect the change-speed operation of the automatic transmission and the performance thereof (refer to Patent Document No. 1) . In this case, since a thrust roller bearing which bears an axial load is provided between the finally assembled component and the housing, from time to time, this thrust roller bearing is constituted to come together with the washer or the like as a set.

Since the assembly gap varies in degree variously, however, several types or ten or more types of washers as gap adjusting members need to be prepared, and this increases manhours for management of washers and the like and the number of components involved, thereby calling for an increase in production cost In addition, even in the event that a number of types of washers and the like are prepared, depending on the degree of an assembly gap, there may be a case where no washer is produced which matches the assembly gap with high accuracy, and in that case, it becomes difficult to adjust the assembly gap with high accuracy.

Patent Document No. 1: JP-B-06-100221

### SUMMARY OF THE INVENTION

A problem that the invention is to solve is to enable the implementation of adjustment of an assembly gap generated by the dispersion in dimensions of components or the like at low costs. Another problem that the invention is to solve is to enable the implementation of adjustment of the assembly gap with high accuracy.

To solve the problem, a first aspect of the present invention provides a thrust roller bearing apparatus installed in a gap occurs between first and second members which constitute a hydraulic mechanism, the thrust roller bearing apparatus comprising: a race axially movably disposed inside the gap; and a plurality of rollers disposed between the race and the first member, wherein an oil pressure chamber is defined between the race and the second member opposed to the race in an axial direction, and the oil pressure chamber presses and displaces the race in the axial direction to increase a capacity of the oil pressure chamber as internal pressure of the oil pressure chamber increases, thereby adjusting the gap. The first and second members include not only the housing of thie hydraulic mechanism but also components making up the hydraulic mechanism.

According to this aspect of the invention, when oil is supplied to the oil pressure chamber in accordance with the degree of the gap so as to increase the internal pressure, the race is pressed against and is then displaced in the axial direction, whereby the adjustment of the gap is carried out by increasing the volume occupied by the oil pressure chamber within the gap. In this case, since the thrust roller bearing is such as to be installed in the hydraulic mechanism to bear the axial load of the respective constituent components of the hydraulic mechanism, the thrust roller bearing which is originally installed can be used as a bearing which adjusts the gap in the assembling direction, thereby obviating the necessity of gap adjusting members such as washers which are disposed exclusively for that purpose, thereby making it possible to realize reductions in the nudber of comoporents involved, components management costs and assembling costs, In addition, according to the first aspect of the invention, being different from the gap adjustment using the gap adjusting members such as washers, since the gap can be adjusted highly accurately by virtue of hydraulic adjustment, the performance or operation of a hydraulic mechanism or the change-speed performance and change-speed operations of an automatic transmission can be exhibited sufficiently,

According to a second aspect of the invention, there is provided a thrust roller bearing apparatus as set forth in the first aspect of the invention, wherein a flange portion is provided at a radial end portion of the race in such a manner as to axially fare a side wall surface of the housing of the hydraulic mechanism and a seal mechanism is provided on the flange portion which maintains a hermetically sealed state of the oil pressure chamber between the side wall surface and the seal mechanism itself so as to enable the axial movement of the bearing This seal mechanism can be configured such that an annular recessed portion is provided on the side wall surface, so that a contact seal such as an O ring is fitted in the annular recessed portion so provided. Alternatively, the seal mechanism can be configured such that a contact seal such as an O ring is fixed to the flange portion, so that the O ring can be brought into contact with the side wall surface.

According to a further preferred aspect of the invention, the oil pressure chamber is formed by a space defined by a back side of the race and a bottom wall surface of the housing, and an oil supply hole is opened in the bottom wall surface for communication with an inside of the oil pressure chamber, so that oil can be supplied to the oil pressure chamber from the oil supply hole so provided.

According to the invention, the gap generated due to the dispersion in dimensions of the constituent components of the hydraulic mechanism and/or dispersion in assembly dimensions thereof can be adjusted without using the exclusive gap adjusting component such as the washer, which is separate from the thrust roller bearing, thereby making it possible not only to reduce the number of components and assembling manhours but also to enable a highly accurate gap adjustment.

### BRIEF DESCRIPTION OF THE DRAWINGS

FIG. 1 is a sectional view whish shows a housing of an automatic transmission and a thrust roller bearing apparatus according to an embodiment of the invention which is to be installed in the housing

FIGS. 2A and 2B are diagrams which explain an assembly gap adjustment operation performed by the thrust roller bearing apparatus.

FIG. 3 is a sectional view whish shows a housing of an automatic transmission and a thrust roller bearing apparatus according to another embodimnent of the invention which is to be installed in the housing.

10: thrust roller bearing; 10a: race; 10a1: race main body; 10a2: radially outside flange portion; 10a3: radially inside flange portion; 10a4: projection; 10b: roller; 10c: retainer; 12: housing (mating member); 12a: bottom wall surface; 12b: radially outside side wall surface; 12c: radially inside side wall surface; 12d: oil supply hole; 12e: bottom wall; 13: automatic transmission shaft; 14: one-way valve; 16: finally assembled component; 18: seal mechanism; 18a: radially outside seal portion; 18b: radially inside seal portion; 20: oil pressure chamber.

### DETAILED DESCRIPTION OF PREFERRED EODIMENTS

Hereinafter, thrust roller bearing apparatus according to embodiments of the invention will be described in detail with reference to the accompanying drawings. In the embodiments, a hydraulic mechanism into which a thrust roller bear.i ng is installed will be described as an automatic transmission, the hydraulic mechanism to which the invention can be applied is not limited thereto.

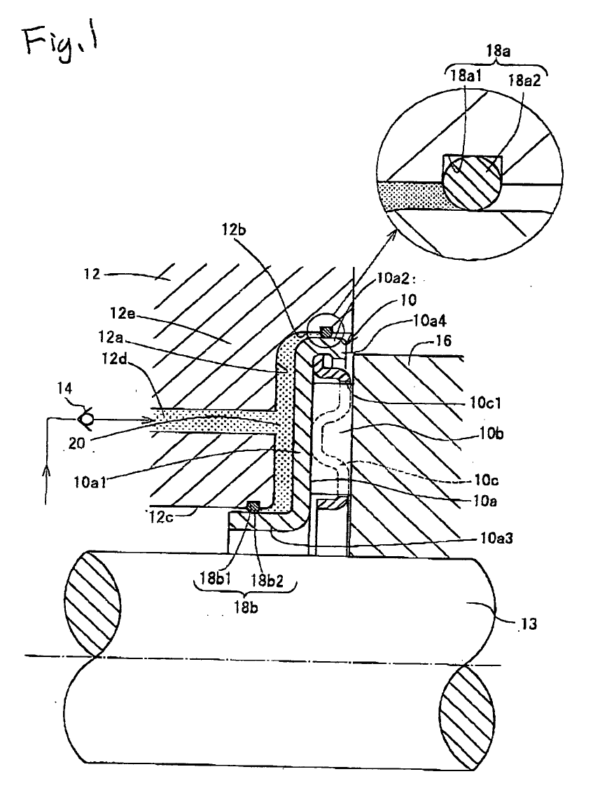

Referring to FIG. 1, a thrust roller bearing 10 is installed in the inside of a housing (a mating member) 12 of an automatic transmission, The housing 12 has an annular bottom wall surface 12a, an annular outside diameter-side or radially outside side wall surface 12b which rises in an axial direction from a radially outside circumferential edge portion of the bottom surface wall 12a and an annular inside diameter-side or radially inside side wall surface 12c which descends in the other axial direction from a radially inside circumferential edge portion of the bottom wall surface 12a.

The trust roller bearing 10 is held between the bottom wall surface 12a of the housing 12 and a finally assembled component 16 of components which are axially assembled into the automatic transmission along an automatic transmission shaft 13 such as an input shaft or an output shaft. The thrust roller bearing 10 includes an annular race 10a, a plurality of needle rollers 10b and ann-shaped cage or retainer 10c. The race 10a includes a race main body 10a1 which extends in a radial direction. A radially outside flange portion 10a2 is provided at a radially outside end portion of the race main body 10a1 in such a manner as to extend annularly in an axial direction while oppositely facing the radially outside side wall surface. A radially inside flange portion 10a3 is provided at a radially inside end portion of the race main body lOal in such a manner as to extend annularly in the axial direction while oppositely facing the radially inside side wall surface Projections 10a4 which projects radially inwardly are provided on an end portion of the radially outside flange portion 10a2 at several circumferential locations. The X-shaped retainer 10c is formed into a shape having an M-shaped circumferential section, and pockets 10c1 are provided therethrough at a plurality of circumferential locations, and the needle rollers 10b are accommodated in the pockets 10c1 in such a manner as not to be dislodged therefrom. A radially outside end portion of the retainer 10c is brought into abutment with an inner surface of the radially outside flange portion 10a2 of the race 10a, so as to be prevented from being dislodged therefrom to an axial side by the projections 10a4 on the radially outside flange portion 10a2.

A back side of the race main body 10a1 defines an oil pressure chamber 20 between the bottom wall surface 12a, which is anating member, and itself. The oil pressure chamber 20 is sealed up by means of radially outside and radially inside seal mechanisms 18a, 18b. The radially outside seal mechanism lga is made up of a recessed portion (an O ring mounting portion) 18a1 provided on the radially outside side wall surface l2b and an annular O ring 18a2 which is fitted in the recessed portion 18a1. The radially inside seal mechanism 18b is made up of a recessed portion (an O ring mounting portion) 18b1 provided on the radially inside side wall surface 12c and an annular O ring 18b2 which is fitted in the recessed portion 18b1.

Since the radially outside and radially inside seal mechanisms 18a, 18b are provided, respectively, between the radially outside and radially inside flange portions 10a2, 10a3 and the radially outside and radially inside side wall surfaces 12b, 12c, the thrust roller bearing 10 can be displaced in the axial direction.

While the radially outside flange portion 10a2 and the radially inside flange portion 10a3 constitute, respectively, contact portions with which the O rings 18a2, 18b2 of the respective seal mechanisms 18a, 18b are brought into contact, the respective ilange portions 10a2, 10a3 can constitute, respectively, O ring mounting portions. As this occurs, the radially outside side wall surface 12b and the radially inside side wall surface 12c constitute, respectively, contact portions with which the O rings 18a2, 18b2 are brought into contact.

In place of the O rings 18a2, 18b2, normal contact seals may be disposed in the recessed portions 18a1, 18b1, so that lips of the contact seals are brought into contact with a side of the mating member. In a case where the contact seals are used, the leakage of oil can be prevented by changing the shapes of the lips of the seal and adjusting a force to tightly press the lips against the mating member. In this specification, provided that seals can effect a hermetical seal which can prevent the leakage of oil frorn the oil pressure chamrber 20 to such an effect that the trust roller bearing can maintain the gap adjusting function, the seals can replace the O rings 18a2, 18b2.

The thrust roller bearing 10 is made to implement the gap adjustment within the housing 12 of the automatic transmission by being displaced to the axial side as the back side of the thrust roller bearing 10 is pushed to the axial side by virtue of a hydraulic pressure exerted thereon from the oil pressure chamber 20

An oil supply hole 12d with a one-way valve 14 is opened in a bottom wall 12e of the housing 12 so as to communicate with the inside of the oil pressure chamber 20. The one-way valve 14 may be mounted in the inside of the oil supply hole 12d or the inside of another oil supply hole which communicates with the oil supply hole 12d. This one-way valve 14 may be any valve which can be opened by virtue of oil pressure, however, a valve may be used which can be controlled to open and close by a computer or the like, which is not shown in the figures, and hence an electromagnetic valve may be used in place of the one-way valve For example, the electromagnetic valve may be controlled to open and close such that oil is discharged from the oil pressure chamber 20 when there is being an excessive internal pressure within the oil pressure chamber 20, whereas when the oil pressure chamber 20 lacks in internal pressure, oil is supplied to the oil pressure chamber The oil pressure chamber 20 is constructed such that the internal pressure thereof is increased when supplied with oil from the oil supply hole 12d.

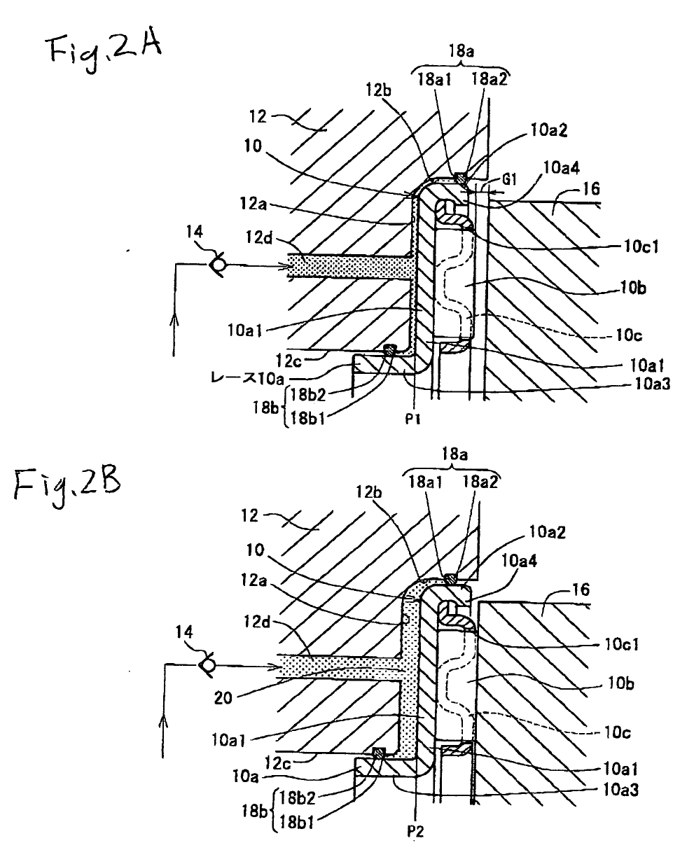

The operation of the thrust roller bearing 10 of the invention will be described by reference to FIG. 1. FIG. 2A shows a state where an assembly gap has not yet been adjusted, and FIG. 2B shows a state where the assembly gap has been adjusted. As shown in FIG. 2A, an assembly gap resulting before an assembly gap adjustment is implemented is G1, and the position of the back side of the race main body 10a1 of the race 10a of the thrust roller bearing 10 is situated at an axial position P1. Oil is supplied from an oil supply, not shown, to the oil pressure chamber 20 via the oil supply hole 12d to deal with the assembly gap G1, and as a result of the supply of oil, the internal pressure of the oil supply chamber 20 is increased. The back side of the race main body loal of the race 10a of the thrust roller bearing 10 is pushed to an axial side as the internal pressure in the oil pressure chamber 20 increases, whereby the position of the back side of the race main body 10a1 of the race 10a is, as shown in FIG. 2B, displaced to an axial position P2 This expands the volume of the oil pressure chamber 20, whereby the gap is adjusted. As this occurs, since the thrust roller bearing 10 can be displaced axially together with the race 10a, the expansion in volume of the oil pressure chamber 20 is permitted. By this operation, the assembly gap G1 is preferably adjusted to zero. While the internal pressure in the oil pressure chamber 20 drops since the volume of the oil pressure chamber 20 is expanded due to the race lOa being displaced axially when the internal pressure is attempted to be increased, the volume of the oil pressure chamber 20 cannot be expanded even when the internal pressure in the oil pressure chamber 20 is increased once the assembly gap is adjusted, for example, to zero, and in the event that the supply of oil from the oil supply hole 12d continues, the internal pressure continues to increase. Then, in order to stop the supply of oil from the oil supply hole 12d after the completion of adjustment of the assembly gap, a sensor is disposed in the oil pressure chamber 20 or the oil supply hole 12d or at any other location so as to detect a change in the internal pressure of the oil pressure chamber 20 to thereby stop the operation of a hydraulic pump or the like, thereby making it possible to stop the supply of oil from the oil supply from the oil supply hole 12d.

As has been described heretofore, the thrust roller bearing 10 in the embodiment is such as to be installed in the interior of the hydraulic mechanism such as an automatic transmission to bear axial load therein, and since the thrust roller bearing 10 not only functions to bear axial load as originally designed but also doubles as a member which performs the assembly gap adjusting function, the necessity of the conventional assembly gap adjusting component such as the washer is obviated, and hence, the number of components involved is reduced. Moreover, as conventionally done, a number of types of gap adjusting components such as washers and the like are no more required to be prepared with much cost, thereby making it possible to remarkably reduce component cost, components management cost, components assembly cost and the like. Furthermore, since the thrust roller bearing 10 can be displaced axially in a continuous fashion in accordance with the degree of an assembly gap, the assembly gap can be adjusted with higher accuracy than done with the conventional gap adjusting members such as washers and the like.

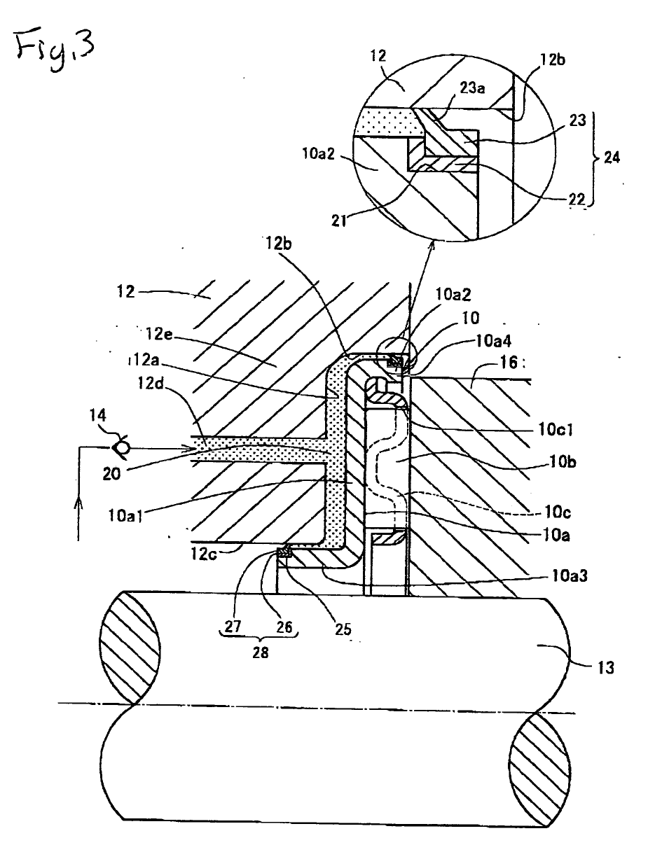

Next, another embodiment of the invention will be described by reference to FIG. 3. Note that like reference numerals are given to like constituent components or constructions to those described with respect to the aforesaid embodiment and the description thereof will be omitted.

Referring to FIG. 3, a stepped portion 21 on which a recessed portion is formed around a full circumference thereof is provided at a corner portion of an axial end portion of an outer circumference of a radially outside flange portion 10a2 of a race main body 10a1 of a thrust roller bearing 10, and a contact seal 24 is fitted in the recessed portion 21 which is made up of a core metal 22, formed into an L-shape as viewed in section, which is to be fitted in the stepped portion 21 and a resin seal portion 23 having a lip 23a (refer to FIG. 3 which is an enlarged diagram showing a main part of the thrust roller bearing 10). Furthermore, a stepped portion 25 on which a recessed portion is formed around a full circumference thereof is provided at a corner portion of an axial end portion of an outer circumference of a radially inside flange portion 10a3 of the race main body 10a1, and a contact seal 28 is fitted in the recessed portion 25 which is made up of a core metal 26, formed into an L-shape as viewed in section, which is tobe fitted in the stepped portion 25 and a resin seal portion 27 having a lip. The lip 23a of the contact seal 24 is such as to be brought into contact with a radially outside side wall surface 12b of a housing 12 The lip of the contact seal 28 is such as to be brought into contact with a radially inside side wall surface 12c of the housing 12. Since oil is supplied to fill a space portion between the race main body 10a1 and the housing 12 which is seal off by the contact seals 24, 28, so as to press the thrust roller bearing 10 against a finally assembled components 16 by virtue of the oil which fills the space portion, no gap is designed to be produced between the thrust roller bearing 10 and the finally assembled component 16.

Note that in addition to the aforesaid embodiments, the invention can be modified variously to be carried out without departing from the scope of the accompanying claims.

What is claimed is:

1. A thrust roller bearing apparatus installed in a gap occurs between first and second members which constitute a hydraulic mechanism, the thrust roller bearing apparatus comprising:
a race axially movably disposed inside the gap; and
a plurality of rollers disposed between the race and the first member,
wherein an oil pressure chamber is defined between the race and the second member opposed to the race in an axial direction, and
wherein the oil pressure chamber presses and displaces the race in the axial direction to increase a capacity of the oil pressure chamber as internal pressure of the oil pressure chamber increases, thereby adjusting the gap.

2. The thrust roller bearing apparatus according to claim 1, wherein
a flange portion is provided at a radial end portion of the race so as to axially face a side wall surface of the second member, and
a seal mechanism is provided on the flange portion for maintaining a hermetically sealed state of the oil pressure chamber between the side wall surface and the flange portion so as to allow the axial movement of the bearing.

3. The thrust roller bearing apparatus according to claim 1, wherein an oil supply hole communicating with the oil pressure chamber for supplying oil is formed through the second member.
